(19) United States
(12) Patent Application Publication
(10) Pub. No.: US 2025/0314107 A1
(43) Pub. Date: Oct. 9, 2025

(54) CARAVAN LOCK WITH ANTI-MOTOR STALLING LINKAGE STRUCTURE

(71) Applicant: NINGBO SHENGJIU TECHNOLOGY CO., LTD, Yuyao City (CN)

(72) Inventors: Chunliang YAO, Yuyao City (CN); Xianquan HUANG, Yuyao City (CN); Liming MAO, Yuyao City (CN)

(73) Assignee: NINGBO SHENGJIU TECHNOLOGY CO., LTD, Yuyao City (CN)

(21) Appl. No.: 19/193,061

(22) Filed: Apr. 29, 2025

Related U.S. Application Data
(63) Continuation of application No. PCT/CN2024/101050, filed on Jun. 24, 2024.

(30) Foreign Application Priority Data
Apr. 3, 2024 (CN) 202420678618.2

(51) Int. Cl. E05B 81/46; E05B 81/06; E05B 81/30; E05B 81/34; E05B 81/90; E05B 83/44

(52) U.S. Cl. CPC E05B 81/46; E05B 81/06; E05B 81/30; E05B 81/34; E05B 81/90; E05B 83/44

(57) ABSTRACT

A caravan lock with anti-motor stalling linkage structure is equipped with a toothed clutch mechanism or a ratchet clutch mechanism. The toothed clutch mechanism is featured by a rotary sliding tooth disc and an inner tooth disc, the drive shaft of the rotary shaft motor is connected to the inner tooth disc of the rotary sliding tooth disc, and the surface of the inner tooth disc has evenly spaced holes allowing for elastic deformation. The outer diameter of the internal gear disc features a braking head wedged into the internal tooth grooves evenly spaced along the inner diameter of the rotary sliding tooth disc; while the end of the linkage is pivotally attached to the first pin located at the top of the rotary sliding tooth disc, the second pin at the top of the rotary sliding gear disk is inserted into the sliding hole of the small locking tongue.

### FIELD OF TECHNOLOGY

The present invention relates to a caravan lock, or specifically, is a caravan lock with anti-motor stalling linkage structure.

### BACKGROUND OF THE INVENTION

Currently, the global caravan market is driven on a growing scale, leading to robust market demand. In addition to traditional mechanical locks, the advancement of electronic technology has facilitated the gradual acceptance of intelligent caravan locks and high-tech products within the market. Concurrently, as intelligent technology continues to develop and gain popularity, intelligent caravan locks are anticipated to become increasingly sophisticated. Typically, intelligent door locks utilize methods such as passwords, fingerprints, and facial recognition for access, with features like automatic unlocking becoming a prevalent trend, thereby elevating user experience. According to Chinese patent documents, specifically publication number 202110934901.8, date of publication: Jun. 14, 2022, the invention titled “A waterproof and shockproof electronic intelligent caravan lock” includes a primary locking structure featuring an outer handle, a first lock cylinder assembly attached to the outer handle, and a switching locking tongue. This switching locking tongue is housed within a mounting cavity, with the outer handle disposed on the front side of the base, allowing both the outer and inner handles to control the locking and unlocking operations of the switching locking tongue; the secondary locking structure comprises a second lock cylinder assembly, a safety bolt, a connecting assembly, and an electronic locking device, with the safety bolt and connecting assembly set in the mounting cavity, and the unlocking knob set on the reverse side of the inner plate. The connecting assembly is attached to the second lock cylinder assembly, the safety bolt and the unlocking knob. The unlocking knob and the second lock cylinder assembly control the locking and unlocking operations of the safety bolt through the linkage assembly; the worm gear facilitates the rotation of the connection rotating sleeve through static friction, which is then transformed into the linear motion of the safety bolt. Nevertheless, the aforementioned product, along with similar items featuring anti-slip friction and anti-stalling structures, as well as the linkage mechanism that prevents the locking tongue from post-unlocking reverting, and unlocking methods for both internal and external access, fall under existing conventional techniques. Additionally, various caravan locks feature a locking tongue lock structure, with two primary types of locking tongue lock mechanisms available in the market: 1. A friction electric lock that operates by utilizing spring pressure to rotate the linkage, which results in higher power consumption; 2. A dual linkage mechanism that facilitates the locking structure, enabling the switching operations of locks. Both of these unlocking methods exhibit some deficiencies, including complex structures and challenges in controlling friction drag force.

### SUMMARY OF THE INVENTION

To address the aforementioned deficiencies, the object of the current invention is to introduce a caravan lock with anti-motor stalling linkage structure. This innovation aims to rectify the limitations found in existing similar products, which are often characterized by a relatively simplistic clutch mechanism structure, the absence of braking design and toothed clutch mechanism configurations. Additionally, the design of the worm clutch mechanism, including the worm gear and worm friction structure, is not good enough, resulting in a complex assembling process and notable production challenges, as well as high power consumption during unlocking. The intended purpose is attained through the technical solutions as described below.

A caravan lock with anti-motor stalling linkage structure, a housing is provided positioned between a base and a pressure plate assembly, an outer door opening panel is situated within a groove on one side of the upper section of the base, with one side of this panel being pivotally attached to the base, allowing for flip-over movement. A keypad assembly is provided on the opposite symmetrical side of the top of the base, which consists of a combination key and a key PCB. Additionally, the bottom side of the pressure plate assembly adjacent to the outer door is equipped with an inner door opening panel, which is also pivotally attached to the pressure plate assembly in a flipping manner. The housing comprises a motor, a small locking tongue, a large locking tongue, a PCB assembly, and either a toothed clutch mechanism or a ratchet clutch mechanism. The key PCB, motor, and PCB assembly are interconnected via wiring, with both the small and large locking tongues extending from the housing. One end of the small locking tongue and the large locking tongue protrudes from one side of the housing, while the opposite end of the large locking tongue within the housing is equipped with a large locking tongue spring. The inner lever disposed on the flipping side of the inner door opening panel is inserted into the large locking tongue sliding hole at the end of the large locking tongue spring via the pressure plate assembly; the outer door opening panel or keypad assembly features a first lock cylinder assembly mounted on that base, with one end of the cylinder extending from the bottom of the base and connecting to the manual unlocking lever within the housing. The shaft at the other end extends out of the pressure plate assembly to connect with the first inner unlocking lever, or alternatively, the shaft located on the other end of the manual unlocking lever may connect to the ratchet clutch mechanism, the second inner manual locking tongue of the clutch mechanism extending from the pressure plate assembly is attached to the second inner unlocking lever; wherein the small locking tongue is a first small locking tongue, and the motor is a rotary shaft motor. The toothed clutch mechanism comprises a rotary sliding tooth disc and an inner tooth disc. The toothed clutch mechanism is installed within the housing through the inner tooth disc. The drive shaft of the rotary shaft motor is attached to the center hole of the inner tooth disc which is disposed within the rotary sliding tooth disc. The surface of the inner tooth disc is designed with evenly spaced holes that allow for elastic deformation. The outer diameter of the inner tooth disc is provided with at least one side of the protruded braking head. Additionally, the outer diameter of the internal gear disc features a braking head wedged into the internal tooth grooves that are evenly spaced along the inner diameter of the rotary sliding tooth disc, or alternatively, The braking head of the inner tooth disc is wedged along the inner diameter of the rotary sliding tooth disc, which features evenly spaced inner tooth grooves along its inner diameter, as well as a rubber sleeve. The rubber sleeve and the rotary sliding tooth disc are linked together as a unit; within the housing, the shaft of the manual unlocking lever is fitted with an inner manual locking tongue, one side of this inner manual locking tongue extends outward and is pivotally attached to one end of the unlocking linkage, while the opposite end of the linkage is pivotally attached to the first pin located at the top of the rotary sliding tooth disc. Furthermore, a second pin at the opposite end of the top of the rotary sliding tooth disc is inserted into the small locking tongue sliding hole of the first small locking tongue. The said toothed clutch mechanism substitutes for the existing worm clutch mechanism, making it easier to assemble parts and reduce space usage.

Protruded limit stops are located on both sides of the outer diameter of the rotary sliding tooth disc, and limit stop bars are disposed within the housing or at the bottom of the base corresponding to the limit stops at least one side. The above structure facilitates limits on locking or unlocking positions of the caravan.

The drive shaft the rotary shaft motor that is bent at a 90° angle, allowing it to extend and connect with the center hole of the inner tooth disc within the rotary tooth disc. The above structure reduces the space occupied by the rotary shaft motor and facilitates the power increase of the rotary shaft motor.

A rotary sliding tooth disc in the said toothed clutch mechanism is substituted with a rotary tooth disc sleeve and a rotary tooth disc. The inner diameter teeth of the rotary tooth disc engage with the teeth of the protruded tooth platform located at the bottom of the rotary tooth disc sleeve. The rotary tooth disc sleeve is linked to the rotary tooth disc as a unit, the tooth ring along the outer diameter of the rotary tooth disc is wedged into the braking head of the inner tooth disc, or generate friction with the inner wall of the rotary tooth disc holder for braking purpose. The said rotary tooth disc holder is substituted with the said inner tooth disc. The aforementioned represents a specific embodiment of an alternative toothed clutch mechanism.

The said small locking tongue is a second small locking tongue, and the motor is a worm gear mot [symbol] the ratchet clutch mechanism comprises a manual unlocking lever, a clutch guard, a clutch pressure spring, and a clutch gear. This ratchet clutch mechanism is installed within the housing through the clutch guard, and both the clutch gear and the manual clutch lever are simultaneously secured to the shaft outer of the manual unlocking lever within the housing. The shaft of the manual unlocking lever is fitted into the clutch guard, and a clutch spring is disposed around the shaft outer diameter of the manual unlocking lever within the clutch guard where fitted. Protruded, engaged, and evenly spaced ratchets are provided respectively where the clutch gear engages with the top of the manual clutch lever; one bottom side of the manual clutch lever is provided with a lever, the lever of the manual clutch lever is connected to one end of the second inner manual locking tongue via curved holes on one side of the clutch guard, as well as the small locking tongue sliding hole of the second small locking tongue. The opposite end of the second inner manual locking tongue extends from the pressure plate assembly and connects to the second inner unlocking lever. The worm of the worm gear motor on one side of the drive shaft engages with the clutch gear that extends from the side of the clutch guard, with the clutch gear being a worm gear. The above structure adds a ratchet engagement structure to the worm clutch mechanism, which not only improves the friction and braking effect, but also safety and stability.

The said worm gear motor is set vertically to the inner wall on the opposite side as symmetrical to the end where the small locking tongue. The above structure reduces the space occupied by the worm gear motor and facilitates the power increase of the worm gear motor.

A battery box is provided on the other side of the bottom of said platen assembly (8), and the battery box is connected to the PCB assembly (12) by wiring. The above structure can be powered either by internal power supply or external power supply.

A sealing sleeve is provided in the groove of the base at the bottom of the said outer door panel, and the outer lever of the outer door panel (18) is inserted into the large locking tongue sliding hole of the large locking tongue through the sealing sleeve at the base. The above structure improves the waterproof effect at the outer door panel.

A second lock cylinder assembly is provided in the said outer door panel, and the lock cylinder extending from the bottom of the second lock cylinder assembly is snapped and locked with a lock frame within the outer door opening panel. The outer door opening panel can only be used after the second lock cylinder assembly has been opened and unlocked.

An electric remote control module is provided in the said PCB assembly, and the electric remote control module is wirelessly connected to unlock the door via a key remote control. The caravan lock features a key remote control, which allows for unlocking in addition to the traditional mechanical key and electronic password options.

The invention features a well-considered structural design, with two easily installable clutch mechanisms, low power consumption, and enhanced stability and safety. Additionally, it offers effective waterproofing. This makes it an ideal option for a caravan lock with anti-motor blocking linkage structure, as well as for the structural enhancement of comparable products.

### ACCOMPANYING DRAWINGS

FIG. 1 is a schematic diagram I of an exploded structure of the first embodiment of the present invention.

FIG. 2 is a schematic diagram of the exploded structure of FIG. 1.

FIG. 3 is a schematic diagram of the assembled rear three-dimensional structure of FIG. 1.

FIG. 4 is a schematic diagram of the rear three-dimensional structure of FIG. 3, with the dotted line showing the internal structure.

FIG. 5 is a schematic diagram of the internal part of the structure of FIG. 4, with the dashed lines showing the unlocking linkage, the first internal manual unlocking tongue and the first internal unlocking lever.

FIG. 6 is a schematic diagram of the internal structure of the closed lock state of FIG. 4, with the boxed portion of the diagram showing an enlarged view of the internal structure of the rotary sliding tooth disc.

FIG. 7 is a schematic diagram of the internal structure of the unlocked state of FIG. 6.

FIG. 8 is a schematic diagram of the rear structure of the second embodiment of the utility model, with the internal structure shown in dashed lines in the diagram.

FIG. 9 is a schematic diagram of the exploded structure of FIG. 8.

FIG. 10 is a schematic diagram of the internal structure of the closed lock state of FIG. 8.

FIG. 11 is a schematic diagram of the internal structure of the unlocked state of FIG. 10.

FIG. 12 is a schematic diagram of the improved structure of the toothed clutch mechanism of the first embodiment of the present invention, in which the base and the corresponding structure are omitted, and the frame is the bottom structure of the connection between the rotary tooth disc sleeve and the rotary tooth disc.

FIG. 13 is a schematic diagram of the internal structure of the rotary tooth disc holder of FIG. 12, in which the rotary tooth disc sleeve and the rotary shaft motor are omitted.

Serial numbers and names of the accompanying drawings: 1, first lock cylinder assembly, 2, combination key, 3, keypad PCB, 4, base, 5, manual unlocking lever, 6, unlocking linkage, 7, housing, 8, pressure plate assembly, 9, inner door opening panel, 901, inner lever, 10, large locking tongue spring, 11, large locking tongue, 1101, large locking tongue sliding hole, 12, PCB assembly, 13, rotary sliding tooth disc, 1301, limit stop, 14, first small locking tongue, 15, inner tooth disc, 16, rotary shaft motor, 17, sealing sleeve, 18, outer door opening panel, 1801, outer lever, 19, second lock cylinder assembly, 20, first inner manual unlocking tongue, 21, first inner unlocking lever, 22, second inner unlocking lever, 23, second inner manual unlocking tongue, 24, second small locking tongue, 25, manual clutch lever, 2501, lever, 26, clutch guard, 27, clutch pressure spring, 28, clutch gear, 29, worm motor, 30, rotary tooth disc sleeve, 31, rotary tooth disc, 32, rotary tooth disc holder.

### EMBODIMENTS

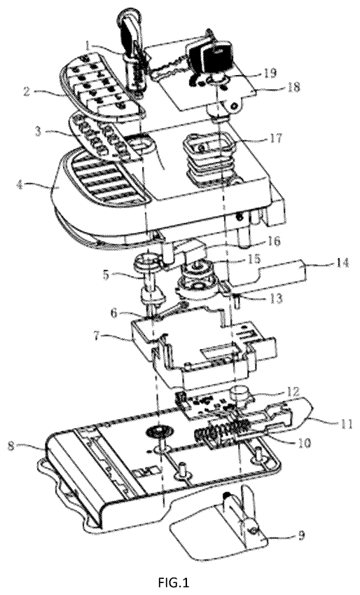

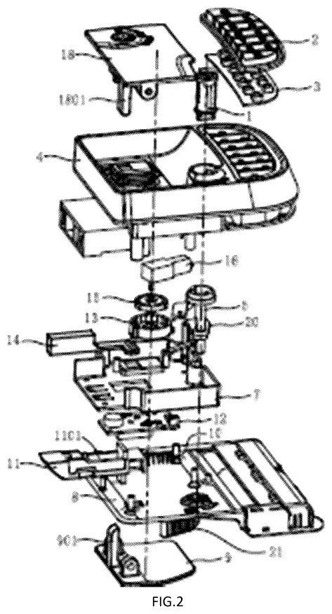

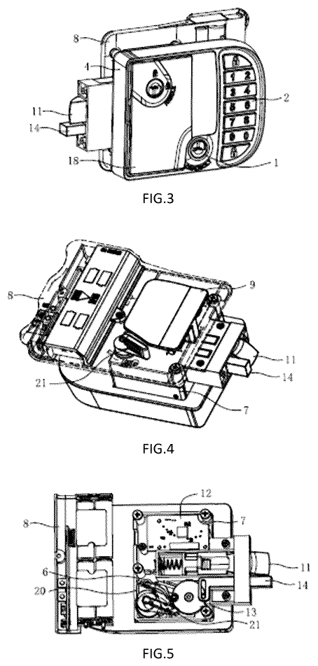

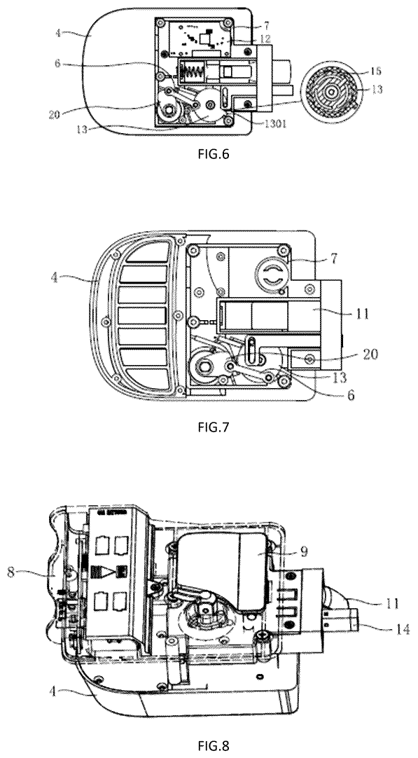

The structure and use of the present invention is further described in conjunction with the accompanying drawings. As shown in FIGS. 1-FIG. 8 in Embodiment 1, a housing 7 is provided positioned between a base 4 and a pressure plate assembly 8, an outer door opening panel 18 is situated within a groove on one side of the upper section of the base, a second lock cylinder assembly 19 is provided in the said outer door panel, and the lock cylinder extending from the bottom of the second lock cylinder assembly is snapped and locked with a lock frame within the outer door opening panel; one side of this panel being pivotally attached to the base, allowing for flip-over movement. A keypad assembly is provided on the opposite symmetrical side of the top of the base, which consists of a combination key 2 and a key PCB 3. Additionally, the bottom side of the pressure plate assembly adjacent to the outer door is equipped with an inner door opening panel 9, which is also pivotally attached to the pressure plate assembly in a flipping manner. The housing comprises a motor, a small locking tongue, a large locking tongue 11, a PCB assembly 12, and either a toothed clutch mechanism or a ratchet clutch mechanism. The key PCB, motor, and PCB assembly are interconnected via wiring, with both the small and large locking tongues extending from the housing. One end of the small locking tongue and the large locking tongue protrudes from one side of the housing, while the opposite end of the large locking tongue within the housing is equipped with a large locking tongue spring 10. The inner lever 901 disposed on the flipping side of the inner door opening panel is inserted into the large locking tongue sliding hole 1101 at the end of the large locking tongue spring via the pressure plate assembly. The outer lever 1801 on the flipping side of the outer door opening panel is inserted into the said large locking tongue sliding hole at the large locking tongue spring end through the base; the outer door opening panel or keypad assembly features a first lock cylinder assembly 1 mounted on that base, with one end of the cylinder extending from the bottom of the base and connecting to the manual unlocking lever 5 within the housing. The shaft at the other end extends out of the pressure plate assembly to connect with the first inner unlocking lever 21, or alternatively, the shaft located on the other end of the manual unlocking lever may connect to the ratchet clutch mechanism, the second inner manual locking tongue 23 of the clutch mechanism extending from the pressure plate assembly is attached to the second inner unlocking lever 22. A sealing sleeve 17 is provided in the groove of the base at the bottom of the said outer door panel, and the outer lever of the outer door panel is inserted into the large locking tongue sliding hole of the large locking tongue through the sealing sleeve at the base. A battery box is provided on the other side of the bottom of said platen assembly, and the battery box is connected to the PCB assembly by wiring.

The said small locking tongue is a first small locking tongue 14, and the motor is a rotary shaft motor 16. The toothed clutch mechanism comprises a rotary sliding tooth disc 13 and an inner tooth disc 15. The toothed clutch mechanism is installed within the housing through the inner tooth disc. The drive shaft of the rotary shaft motor is attached to the center hole of the inner tooth disc which is disposed within the rotary sliding tooth disc. The surface of the inner tooth disc is designed with evenly spaced holes that allow for elastic deformation. The outer diameter of the inner tooth disc is provided with at least one side of the protruded braking head. Additionally, the outer diameter of the internal gear disc features a braking head wedged into the internal tooth grooves that are evenly spaced along the inner diameter of the rotary sliding tooth disc, or alternatively, The braking head of the inner tooth disc is wedged along the inner diameter of the rotary sliding tooth disc, which features evenly spaced inner tooth grooves along its inner diameter, as well as a rubber sleeve. The rubber sleeve and the rotary sliding tooth disc are linked together as a unit; the shaft of the manual unlocking lever is fitted with an inner manual locking tongue 20, one side of this inner manual locking tongue extends outward and is pivotally attached to one end of the unlocking linkage 6, while the opposite end of the linkage is pivotally attached to the first pin located at the top of the rotary sliding tooth disc. Furthermore, a second pin at the opposite end of the top of the rotary sliding tooth disc is inserted into the small locking tongue sliding hole of the first small locking tongue. Protruded limit stops 1301 are located on both sides of the outer diameter of the rotary sliding tooth disc, and limit stop bars are disposed within the housing or at the bottom of the base corresponding to the limit stops at least one side. The drive shaft the rotary shaft motor that is bent at a 90° angle, allowing it to extend and connect with the center hole of the inner tooth disc within the rotary tooth disc.

The unlocking disc of the caravan lock features an anti-sliding tooth design, the combination of a rotary sliding tooth disc and an internal tooth disc, which links with a sliding tooth structure to prevent motor stalling. The rotary shaft motor activates the rotating sliding tooth disc, which in turn either extends or retracts the first small locking tongue. This action is facilitated by the first inner unlocking lever, which is linked to the first internal manual unlocking tongue, allowing for manual unlocking. Consequently, the first small locking tongue is released, and the limit mechanism prevents it from returning to the dead point. Additionally, the mechanical key is designed with a neutral gear for door unlocking.

How to unlock: a command is sent for the rotor shaft motor to rotate reversely, which then drives the rotation of the tooth disc, causing the first small locking tongue to rotate. Once the tongue reaches its designated position, the too disc is limited and secured, thereby completing the electric unlocking process.

How to lock: a command is sent for the rotor shaft motor to rotate forward. This forward rotation drives the rotation of the rotary sliding tooth disc, which in turn causes the first small locking tongue to return. When the tongue reaches the closed position, the tooth disc is limited and secured, finalizing the electric locking action.

Manual or mechanical lock cylinder switching: the first internal unlocking lever is manually rotated. This action causes the unlocking lever to rotate the sliding tooth disc, which subsequently moves the first small locking tongue either by returning or lifting. Once the first small locking tongue reaches the switching position, the rotary sliding tooth disc is constrained, finalizing the manual switching function.

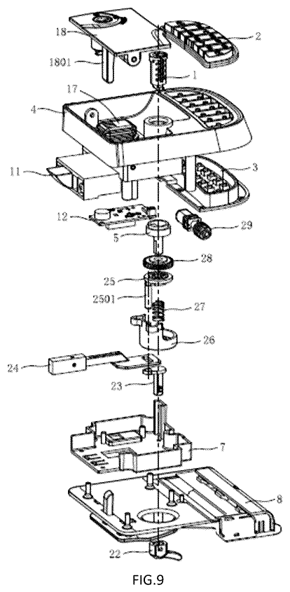

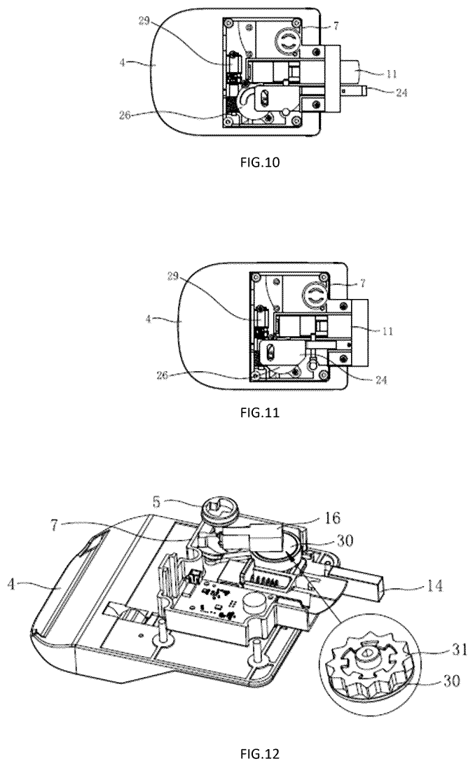

Based on the structural characteristics outlined in the first embodiment, the second embodiment as illustrated in FIGS. 9-11 is based upon the first embodiment, wherein the small locking tongue is a second locking tongue 24, and the motor is a worm gear motor 29. The ratchet clutch mechanism comprises a manual clutch lever 25, a clutch guard 26, a clutch pressure spring 27, and a clutch gear 28. This ratchet clutch mechanism is installed within the housing through the clutch guard, and both the clutch gear and the manual clutch lever are simultaneously secured to the shaft outer of the manual unlocking lever within the housing. The shaft of the manual unlocking lever is fitted into the clutch guard, and a clutch spring is disposed around the shaft outer diameter of the manual unlocking lever within the clutch guard where fitted. Protruded, engaged, and evenly spaced ratchets are provided respectively where the clutch gear engages with the top of the manual clutch lever; one bottom side of the manual clutch lever is provided with a lever 2501, the lever of the manual clutch lever is connected to one end of the second inner manual locking tongue 23 via curved holes on one side of the clutch guard, as well as the small locking tongue sliding hole of the second small locking tongue 22. The worm of the worm gear motor on one side of the drive shaft engages with the clutch gear that extends from the side of the clutch guard, with the clutch gear being a worm gear. The said worm gear motor is set vertically to the inner wall on the opposite side as symmetrical to the end where the small locking tongue and the large locking tongue are extended within the housing.

The unlocking disc of the caravan lock features a ratchet design, the combination of an internal worm gear system alongside the ratchet structure to prevent the motor from stalling. The second internal unlocking lever is connected to the second internal manual unlocking tongue, which links with the manual electric system. Specifically, the worm on the drive shaft of the worm motor facilitates the rotation of the clutch gear, which in turn moves the second small locking tongue to lock or unlock. The second internal unlocking lever operates through the clutch gear to execute the locking mechanism.

How to unlock: a command is issued to the worm gear motor to rotate reversely, which then drives the rotation of the clutch gear in the opposite direction, thereby rotating the second small locking tongue. Once the second small locking tongue reaches its designated position, the manual unlocking lever shaft is constrained by the arc hole of the clutch guard, finalizing the electric unlocking process.

How to lock: a command is issued to the worm gear motor to rotate forward. This forward rotation drives the rotary sliding tooth disc, which in turn rotates the second small locking tongue. When the second small locking tongue reaches the closed position, the manual unlocking lever shaft is again limited by the arc hole of the clutch guard, finalizing the electric locking action.

Manual or mechanical lock cylinder switching: the second internal unlocking lever is manually rotated. This action causes the manual unlocking linkage to rotate the shaft, which subsequently moves the second small locking tongue either by returning or lifting. Once the second small locking tongue reaches the switching position, the shaft of the manual unlocking lever is constrained by the arc hole of the clutch guard, finalizing the manual switching function.

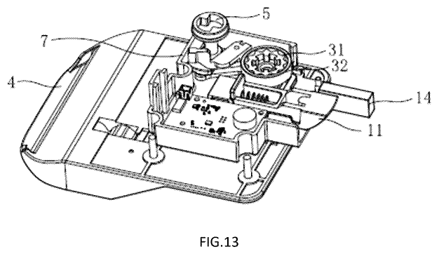

When the first small locking tongue of the first embodiment and the second small locking tongue of the second embodiment are in the unlocked state, the large locking tongue can be unlocked by rotating the outer door opening panel or the inner door opening panel, so as to cause the caravan door to open. At the same time, according to the structural features of the first embodiment described above, the second embodiment as illustrated in FIGS. 12-13 is based upon the first embodiment, wherein a rotary sliding tooth disc in the said toothed clutch mechanism is substituted with a rotary tooth disc sleeve 30 and a rotary tooth disc 31. The inner diameter teeth of the rotary tooth disc engage with the teeth of the protruded tooth platform located at the bottom of the rotary tooth disc sleeve. The rotary tooth disc sleeve is linked to the rotary tooth disc as a unit, the tooth ring along the outer diameter of the rotary tooth disc is wedged into the braking head of the inner tooth disc, or generate friction with the inner wall of the rotary tooth disc holder for braking purpose. The said rotary tooth disc holder is substituted with the said inner tooth disc.

In conclusion, the caravan lock facilitates mechanical unlocking from the exterior of the vehicle by turning forward 90° to unlock and reversing it 90° to lock. Pulling out the key and electric unlocking will not cause the lock cylinder to rotate; for mechanical unlocking from within the vehicle, a forward turn 90° is required to unlock, followed by a reverse turn 90° to lock. This process does not interfere with the functionality of the remote control unlocking or the electric password unlocking. When using the remote key for unlocking, electric unlocking is activated by remote key, and no pull-in of lock cylinder is allowed once unlocked.

1-10. (canceled)

11. A caravan lock with anti-motor stalling linkage structure, a housing is provided positioned between a base and a pressure plate assembly, an outer door opening panel is situated within a groove on one side of the upper section of the base, with one side of this panel being pivotally attached to the base, allowing for flip-over movement, wherein A keypad assembly is provided on the opposite symmetrical side of the top of the base, which consists of a combination key and a key PCB, wherein additionally, the bottom side of the pressure plate assembly adjacent to the outer door is equipped with an inner door opening panel, which is also pivotally attached to the pressure plate assembly in a flipping manner, wherein the housing comprises a motor, a small locking tongue, a large locking tongue, a PCB assembly, and either a toothed clutch mechanism or a ratchet clutch mechanism, wherein the key PCB, motor, and PCB assembly are interconnected via wiring, with both the small and large locking tongues extending from the housing, wherein the end of the small locking tongue and the large locking tongue protrudes from one side of the housing, while the opposite end of the large locking tongue within the housing is equipped with a large locking tongue spring, wherein the inner lever disposed on the flipping side of the inner door opening panel is inserted into the large locking tongue sliding hole at the end of the large locking tongue spring via the pressure plate assembly, wherein the outer lever on the flipping side of the outer door opening panel is inserted into the said large locking tongue sliding hole at the large locking tongue spring end through the base, wherein the outer door opening panel or keypad assembly features a first lock cylinder assembly mounted on that base, with one end of the cylinder extending from the bottom of the base and connecting to the manual unlocking lever within the housing, wherein the shaft at the other end extends out of the pressure plate assembly to connect with the first inner unlocking lever, or alternatively, the shaft located on the other end of the manual unlocking lever may connect to the ratchet clutch mechanism, the second inner manual locking tongue of the clutch mechanism extending from the pressure plate assembly is attached to the second inner unlocking lever, wherein the small locking tongue is a first small locking tongue, and the motor is a rotary shaft motor, wherein the toothed clutch mechanism comprises a rotary sliding tooth disc and an inner tooth disc, wherein the toothed clutch mechanism is installed within the housing through the inner tooth disc, wherein the drive shaft of the rotary shaft motor is attached to the center hole of the inner tooth disc which is disposed within the rotary sliding tooth disc, wherein the surface of the inner tooth disc is designed with evenly spaced holes that allow for elastic deformation, wherein the outer diameter of the inner tooth disc is provided with at least one side of the protruded braking head, wherein the outer diameter of the internal gear disc features a braking head wedged into the internal tooth grooves that are evenly spaced along the inner diameter of the rotary sliding tooth disc, or alternatively, The braking head of the inner tooth disc is wedged along the inner diameter of the rotary sliding tooth disc, which features evenly spaced inner tooth grooves along its inner diameter, as well as a rubber sleeve, wherein the rubber sleeve and the rotary sliding tooth disc are linked together as a unit, wherein the housing, the shaft of the manual unlocking lever is fitted with an inner manual locking tongue, one side of this inner manual locking tongue extends outward and is pivotally attached to one end of the unlocking linkage, while the opposite end of the linkage is pivotally attached to the first pin located at the top of the rotary sliding tooth disc, wherein the second pin at the opposite end of the top of the rotary sliding tooth disc is inserted into the small locking tongue sliding hole of the first small locking tongue.

12. A caravan lock with anti-motor stalling linkage structure according to claim 11, wherein the protruded limit stops are located on both sides of the outer diameter of the rotary sliding tooth disc, and limit stop bars are disposed within the housing or at the bottom of the base corresponding to the limit stops at least one side.

13. A caravan lock with anti-motor stalling linkage structure according to claim 11, wherein the drive shaft the rotary shaft motor that is bent at a 90° angle, allowing it to extend and connect with the center hole of the inner tooth disc within the rotary tooth disc.

14. A caravan lock with anti-motor stalling linkage structure according to claim 13, wherein the rotary sliding tooth disc in the said toothed clutch mechanism is substituted with a rotary tooth disc sleeve and a rotary tooth disc, wherein the inner diameter teeth of the rotary tooth disc engage with the teeth of the protruded tooth platform located at the bottom of the rotary tooth disc sleeve, wherein the rotary tooth disc sleeve is linked to the rotary tooth disc as a unit, the tooth ring along the outer diameter of the rotary tooth disc is wedged into the braking head of the inner tooth disc, or generate friction with the inner wall of the rotary tooth disc holder for braking purpose, wherein the said rotary tooth disc holder is substituted with the said inner tooth disc.

15. A caravan lock with anti-motor stalling linkage structure according to claim 11, wherein the small locking tongue is a second locking tongue, and the motor is a worm gear motor, wherein the ratchet clutch mechanism comprises a manual clutch lever, a clutch guard, a clutch pressure spring, and a clutch gear, wherein this ratchet clutch mechanism is installed within the housing through the clutch guard, and both the clutch gear and the manual clutch lever are simultaneously secured to the shaft outer of the manual unlocking lever within the housing, wherein the shaft of the manual unlocking lever is fitted into the clutch guard, and a clutch spring is disposed around the shaft outer diameter of the manual unlocking lever within the clutch guard where fitted, wherein protruded, engaged, and evenly spaced ratchets are provided respectively where the clutch gear engages with the top of the manual clutch lever, wherein the bottom side of the manual clutch lever is provided with a lever, the lever of the manual clutch lever is connected to one end of the second inner manual locking tongue via curved holes on one side of the clutch guard, as well as the small locking tongue sliding hole of the second small locking tongue, wherein the opposite end of the second inner manual locking tongue extends from the pressure plate assembly and connects to the second inner unlocking lever, wherein the worm of the worm gear motor on one side of the drive shaft engages with the clutch gear that extends from the side of the clutch guard, with the clutch gear being a worm gear.

16. A caravan lock with anti-motor stalling linkage structure according to claim 15, wherein the said worm gear motor is set vertically to the inner wall on the opposite side as symmetrical to the end where the small locking tongue and the large locking tongue are extended within the housing.

17. A caravan lock with anti-motor stalling linkage structure according to claim 11, wherein the battery box is provided on the other side of the bottom of said platen assembly, and the battery box is connected to the PCB assembly by wiring.

18. A caravan lock with anti-motor stalling linkage structure according to claim 11, wherein the sealing sleeve is provided in the groove of the base at the bottom of the said outer door panel, and the outer lever of the outer door panel is inserted into the large locking tongue sliding hole of the large locking tongue through the sealing sleeve at the base.

19. A caravan lock with anti-motor stalling linkage structure according to claim 11, wherein the second lock cylinder assembly is provided in the said outer door panel, and the lock cylinder extending from the bottom of the second lock cylinder assembly is snapped and locked with a lock frame within the outer door opening panel.

20. A caravan lock with anti-motor stalling linkage structure according to claim 11, wherein the electric remote control module is provided in the said PCB assembly, and the electric remote control module is wirelessly connected to unlock the door via a key remote control.
